(19) United States
(12) Patent Application Publication
(10) Pub. No.: US 2005/0126701 A1
(43) Pub. Date: Jun. 16, 2005

(54) Rolls of badge stock for use in printing identification badges in roll-fed printers

(76) Inventors: Jerry G. Hodsdon, Forestdale, MA (US); Adam G. Bratter, Newport Coast, CA (US); Joshua D. Rundus, Boise, ID (US)

Correspondence Address: Eric K. Satermo, P.O. Box 19099, Irvine, CA, 92623-9099, US

(21) Appl. No.: 10/987,176

(22) Filed: Nov. 12, 2004

Related U.S. Application Data
(60) Provisional application No. 60/519,529, filed on Nov. 12, 2003.

(51) Int. Cl. B32B 9/00

(52) U.S. Cl. 156/289; 428/42.3; 428/40.1; 156/277; 156/227

(57) ABSTRACT

A printing stock assembly for printing identification badges with a roll-fed label printer includes a release liner and a plurality of stock badges. The release liner may have a plurality of spaced apart weakening lines. Each of the stock badges includes a face stock and an adhesive layer. The stock badges are releasably attached to the release liner in single-file manner between the weakening lines, respectively. The face stock the stock badges includes a verso half and a recto half divided by a fold line. In addition, the face stock may include a pair of strap apertures formed in the verso and recto halves in a mirror image about the fold line. Accordingly, after printing, a stock badge may be removed from the release liner, thereby exposing the adhesive layer. The face stock may then be folded about the fold line such that the adhesive layer of the verso half is adherent to the adhesive layer of the recto half to form a two-sided identification badge. The strap apertures aligned with each to form a through hole to receive a strap.

### CROSS REFERENCE TO RELATED APPLICATIONS

This application claims priority under 35 U.S.C. § 119(e) on U.S. Provisional Application for Patent Ser. No. 60/519,529 filed Nov. 12, 2003. This application also relates to U.S. Design patent application Ser. No. 29/210,158 filed Jul. 28, 2004. Both of these applications are incorporated herein by reference.

### FIELD OF THE INVENTION

The present invention relates to identification badges. The invention also relates to printing stock that may be printed upon to create identification badges and, more particularly, to such printing stock that is in roll form.

### BACKGROUND OF THE INVENTION

Identification badges have been addressed in many different ways. One of the most common is a self-adhesive identification badge that is adhered directly to clothing. Other identification badges include a rigid plastic substrate on which an adhesive label is applied. A strap with a clip attached to the substrate so that the badge can be attached to clothing. Conventional identification badges are printed in laser or inkjet printers. The printing stock for such conventional badges is configured as a label sheet that is fed into a laser or inkjet printer.

There remains a need in the art for a convenient, inexpensive, and easy-to-use printing stock for making identification badges.

### BRIEF SUMMARY OF THE INVENTION

The present invention relates to identification badges. The invention also relates to printing stock that may be printed upon to create identification badges and, more particularly, to such printing stock that is in roll form.

According to one embodiment of the invention and by way of example only, a printing stock assembly for printing identification badges with a roll-fed label printer includes a release liner and a plurality of stock badges. The release liner may have a plurality of spaced apart weakening lines, thereby defining a panel therebetween. Each of the stock badges includes a face stock and an adhesive layer. The stock badges are releasably attached to the release liner in single-file manner between the weakening lines, respectively. The face stock the stock badges includes a verso half and a recto half divided by a fold line. In addition, the face stock may include a pair of strap apertures formed in the verso and recto halves in a mirror image about the fold line. Accordingly, after printing, a stock badge may be removed from the release liner, thereby exposing the adhesive layer. The face stock may then be folded about the fold line such that the adhesive layer of the verso half is adherent to the adhesive layer of the recto half to form a two-sided identification badge. The strap apertures aligned with each to form a through hole to receive a strap.

One of the advantages of utilizing the printing stock assembly is that identification badges may be made easily and inexpensively. There is no need for a plastic card substrate on which to adhere labels. In addition, information may be printed on both the verso and the recto halves of the face stock so that the resulting identification badge can have information on both the front and the back side of the card.

According to another embodiment, the printing stock assembly may be wound about a core to form a roll of badge stock. The roll of badge stock may be easily mounted in a roll-fed printer so that individual labels can be printed. The weakening lines of the assembly allows a user to tear off individual badge units after printing with a panel of the release liner still attached to the face stock.

Other features and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 illustrates a roll of badge stock according to a number of portrait embodiments;

FIG. 2 illustrates a roll of badge stock according to a number of landscape embodiments;

FIGS. 3A and 3B are front and side views, respectively, of an identification badge in portrait orientation;

FIGS. 4A and 4B are front and side views, respectively, of an identification badge in landscape orientation;

FIG. 5 is a perspective view of a roll-fed label printer;

FIG. 6 is a fragmentary front plan view of a printing stock assembly in portrait orientation;

FIG. 7 is a fragmentary back plan view of a printing stock assembly of FIG. 6;

FIG. 8 is a fragmentary cross-sectional view taken along line 8-8 of FIG. 6;

FIGS. 9A, 9B, and 9C are fragmentary cross-sectional views taken along line 9-9 of FIG. 6, respectively illustrating alternative embodiments of a badge unit;

FIGS. 10A, 10B, and 10C illustrate successive steps in folding a face stock to form a badge;

FIG. 11 is a fragmentary plan view of a printing stock assembly in landscape orientation;

FIG. 12 is a fragmentary front plan view of a printing stock assembly according to a number of embodiments with a liner section;

FIG. 13 is a fragmentary back plan view of a printing stock assembly of FIG. 12;

FIG. 14 is a fragmentary cross-sectional view taken along line 14-14 of FIG. 12;

FIG. 15 is a fragmentary perspective view illustrating a face stock with a liner section being removed from a release liner;

FIG. 16 is a cross-sectional view of the face stock with liner section of FIG. 15 folded to form a badge;

FIG. 17 is a fragmentary perspective view illustrating a face stock without a liner section being removed from a release liner;

FIG. 18 is a fragmentary front plan view of a printing stock assembly according to other embodiments with a liner section;

FIG. 19 is a fragmentary back plan view of a printing stock assembly of FIG. 18;

FIG. 20 is a fragmentary cross-sectional view taken along line 20-20 of FIG. 18; and

FIG. 21 is an exploded perspective view of a roll of badge stock mounted on a spool of a printer.

### DETAILED DESCRIPTION OF THE INVENTION

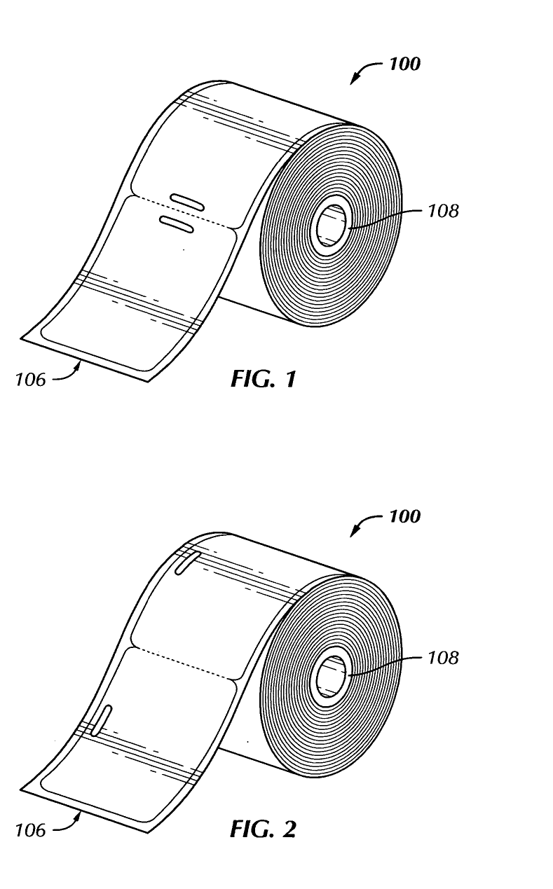

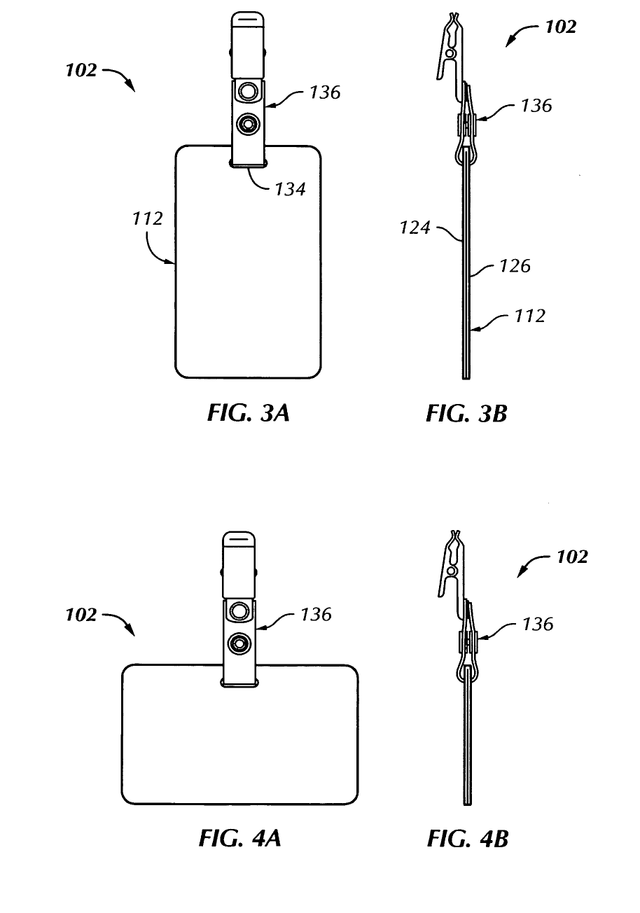

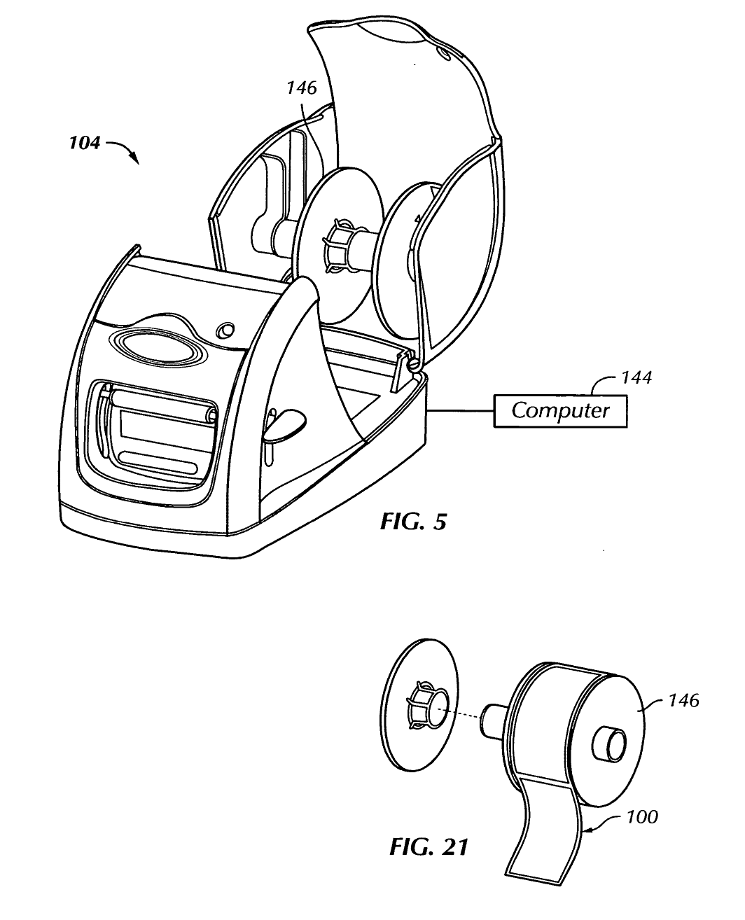

Referring to the drawings in more detail, portrait and landscape embodiments of roll of badge stock 100 are respectively illustrated in FIGS. 1 and 2. The portrait embodiment of the rolls of badge stock 100 shown in FIG. 1 may be used for printing an identification badge 102 with a portrait orientation as shown in FIGS. 3A and 3B. Similarly, the landscape embodiment of the rolls of badge stock 100 shown in FIG. 2 may be used for printing an identification badge 102 with a landscape orientation as shown in FIGS. 4A and 4B. The roll of badge stock 100 may be configured for operation with a roll-fed label printer 104 as shown in FIG. 5. As shown in FIGS. 1 and 2, in a number of embodiments the roll of badge stock 100 may include a printing stock assembly 106 wound about a core 108.

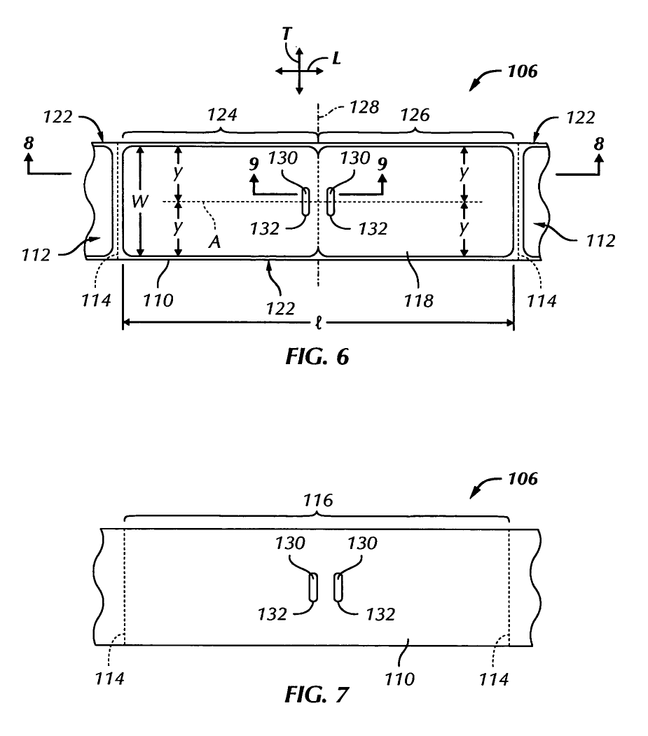

Referring to FIGS. 6 and 7, in a number of embodiments the printing stock assembly 106 may include a release liner 110 and a plurality of stock badges 112. In roll form, the release liner 110 may be longitudinally elongated and may include a plurality of transversely disposed weakening lines 114, with the longitudinal direction and the transverse direction being indicated by arrows L and T in FIG. 6. As shown in FIG.7, a panel 116 of the release liner 110 may be defined between successive weakening lines 114, which will be discussed in more detail below. The stock badges 112 may be spaced apart longitudinally in a single-file manner along the release liner 110 discretely between successive weakening lines 114. In a number of embodiments, the weakening lines 114 may include perforations.

With additional reference to FIG. 8, each of the stock badges 112 may include a face stock 118 and an adhesive layer 120 such that the stock badges 112 are releasable attached to the release liner 110. Accordingly, as shown in FIGS. 6 and 8, the printing stock assembly 106 may be described as including a plurality of badge units 122 each including one of the stock badges 112 and a respective one of the panels 116 (see FIG. 7) of the release liner 110. Individual badge units 122 may be detached from the printing stock assembly 106 along the weakening line 114 either before or after printing. Any type of known label stock may be used for the face stock 118 of the assembly 106.

Referring to FIG. 6, the face stock 118 of each of the stock badges 112 may be include a verso half 124 and a recto half 126 divided by a transverse fold line 128 which is indicted by the phantom line in the drawings. In addition, each of the face stocks 118 may include a pair of strap apertures 130 disposed in a mirror image about the fold line 128 so that each of the halves 124 and 126 has a respective one of the strap apertures 130.

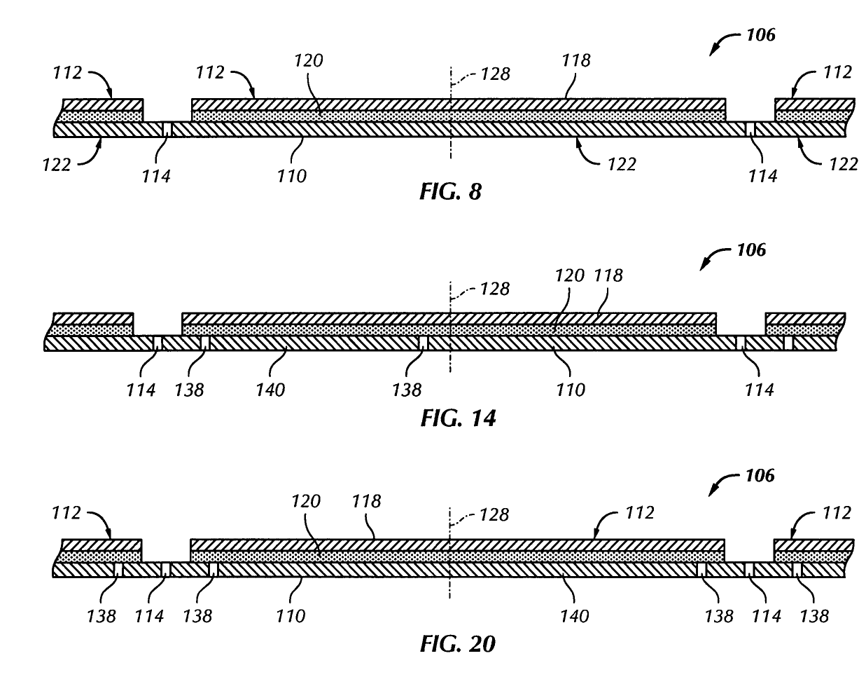

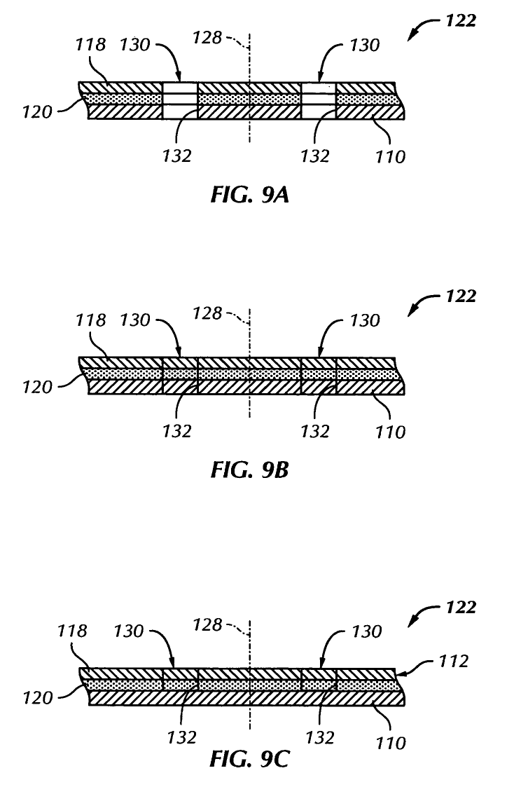

As shown in FIG. 9A, the strap apertures 130 may be formed by making a die cut 132 through the entire badge unit 122 and removing the portion of the badge unit 122 within the cut 132 so that the strap apertures 130 are through holes. Alternatively, as shown in FIG. 9B, the die cut 132 may be made through the layers of the badge unit 122 but the portion of the badge unit 122 within the die cut 132 remaining in place for subsequent removal by a user during badge assembly. Still alternatively, as shown in FIG. 9C, the die cut 132 may be made through the stock badge 112 (i.e., through the face stock 118 and the adhesive layer 120) but not through the liner 110. Accordingly, in this last embodiment, the portion of the stock badge 112 within the die cut 132 may remain attached to the liner 110 when the stock badge 112 is removed from the liner 110 after printing.

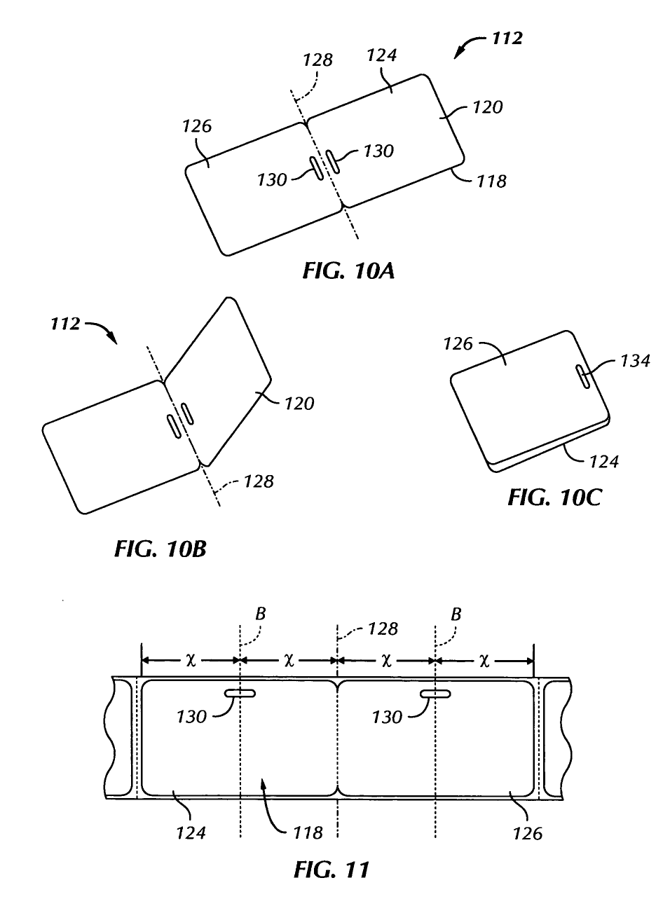

With reference to FIGS. 10A, 10B, and 10C, when removed from the release liner 110, the adhesive layer 120 of a stock badge is exposed. The stock badge 112 may be folded about the fold line 128 with the adhesive layer 120 of the verso half 124 adhering to the adhesive layer 120 of the recto half 126 to form a two-sided identification badge 102. With additional reference to FIG. 3, the verso half 124 of the face stock 118 may define one side (e.g., a front side) of the identification badge 102, and the recto half 126 may define the other side (e.g., a back side) of the identification badge 102. As shown in FIG. 10, the strap apertures 130 substantially align with other to define a through hole 134 through which a strap 136 is receivable as shown in FIG. 3.

In portrait embodiments such as shown in FIGS. 1, 3, and 6, the strap apertures 130 may be substantially transversely centered on the verso and recto halves 124 and 126; that is, a longitudinal center axis A of the apertures 130 is substantially equidistant between opposing edges of the face stock 118 as indicated by alpha y. Accordingly, when the stock badge 112 is folded about the fold line 128, the resulting identification badge 102 has a portrait orientation.

Alternatively, in landscape embodiments as shown in FIGS. 2, 4, and 11, the strap apertures 130 may be substantially longitudinally centered on the verso and recto halves 124 and 126; that is, respective center axes B of the apertures 130 are substantially equidistant between the fold line 128 and opposing ends of the face stock 118 as indicated by alpha x. Accordingly, when the stock badge 112 is folded about the fold line 128, the resulting identification badge 102 has a landscape orientation.

For the purposes of this description, the term “portrait” is used to describe the normal reading/viewing orientation of a piece of media (e.g., a piece of paper) in which the vertical sides are longer than the horizontal sides, and the term “landscape” is used to describe the normal reading/viewing orientation of a piece of media in which the horizontal sides are longer than the vertical sides, which definitions accord the common usage of these terms in the art.

With further reference to FIG. 6, the face stock 118 may have a longitudinal length l and a transverse width w. Accordingly, the verso and the recto halves 124 and 126 of the face stock 118 may also have a longitudinal length that is about one-half the length l of the face stock 118 and a transverse width that is about equal of the width w of the face stock 118. In a number of embodiments, the length of each half 124 and 126 (i.e., l/2) may be greater than the width w. For example, the face stock 118 may have a length l of about 6¾ inches (i.e., the length of each of the halves 124 and 126 may be about 3⅜ inches) and a width w of about 2⅛ inches. Accordingly, when folded to form a badge 102, the badge 102 may have dimensions of about 3⅜ inches by about 2⅛ inches, which are the dimensions of a standard sized identification badge.

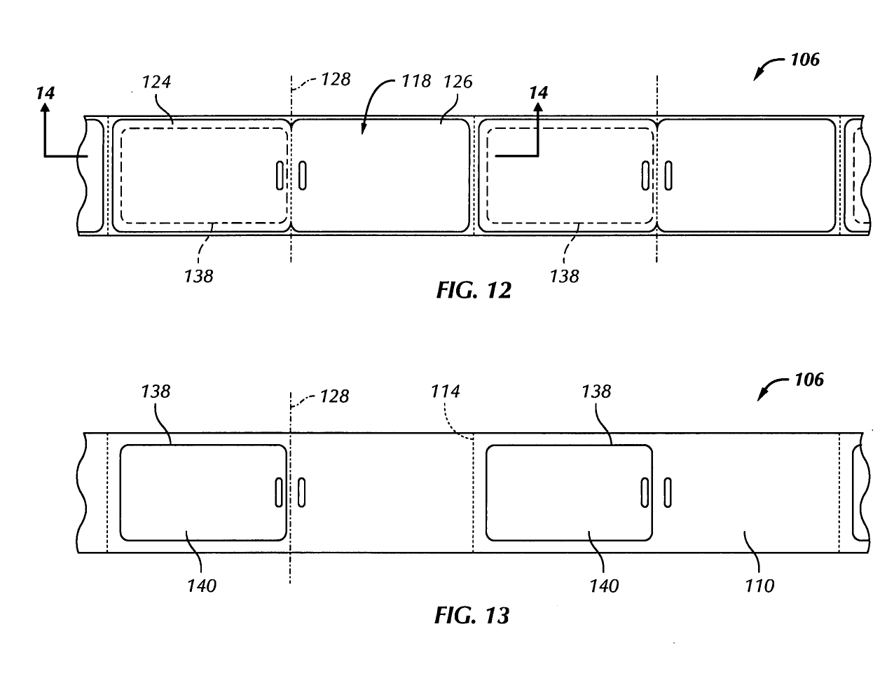

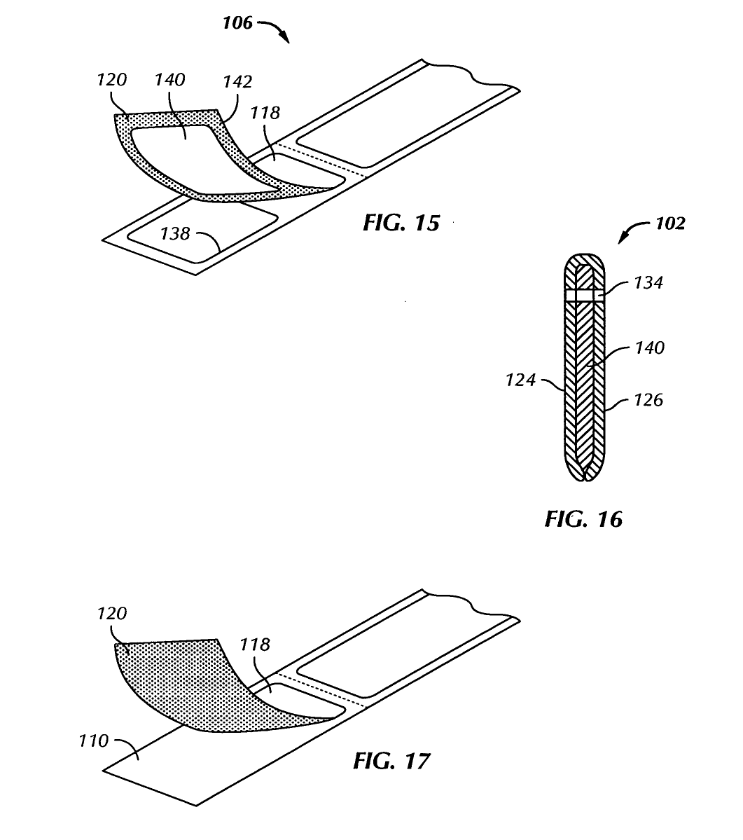

With reference to FIGS. 12, 13 and 14, in a number of embodiments the release liner 110 of the printing stock assembly 106 may include a plurality of liner cuts 138 defining a plurality of liner sections 140. As particularly shown by phantom line in FIG. 12, the liner sections 140 may be smaller in size than the face stock 118 and located spatially within the face stock 118. As shown in FIG. 15, when one of the face stocks 118 is removed from the release liner 110, a corresponding one of the liner sections 140 remains adhered to the removed face stock 118. The smaller dimensions of the liner section 140 (compared to the dimensions of the face stock 118 itself) results in a peripheral section 142 of the adhesive layer 120 being exposed.

Accordingly, when the removed face stock 118 is folded about the fold line 128, the liner section 140 is sandwiched between the verso and recto halves 124 and 126 of the face stock 118 as shown in FIG. 16. In contrast, in the embodiments shown in FIGS. 6 and 7 which are free of liner cuts, when the face stock 118 is removed from the liner 110, the entire adhesive layer 120 is exposed as shown in FIG. 17. The presence of the liner section 140 may mitigate the tendency of the face stock 118 to curl resulting from being in roll form.

For the purposes of this description, the term “spatially located” is used to describe the spatial and/or dimensional relationship between the various elements of the assembly 106. For example, referencing FIG. 12, a liner section 140 may be described as being spatially located within the face stock 118, which indicates that the liner section 140 has at least one dimension that is smaller than a corresponding dimension of the face stock 118 and that the liner section 140 is positioned with respect to the face stock 118 such that liner section 140 does not project beyond any of the edges or sides of the face stock 118. As another example, as shown in FIGS. 6 and 7, in a number of embodiments the face stock 118 may be spatially located within a panel 116 of the release liner 110.

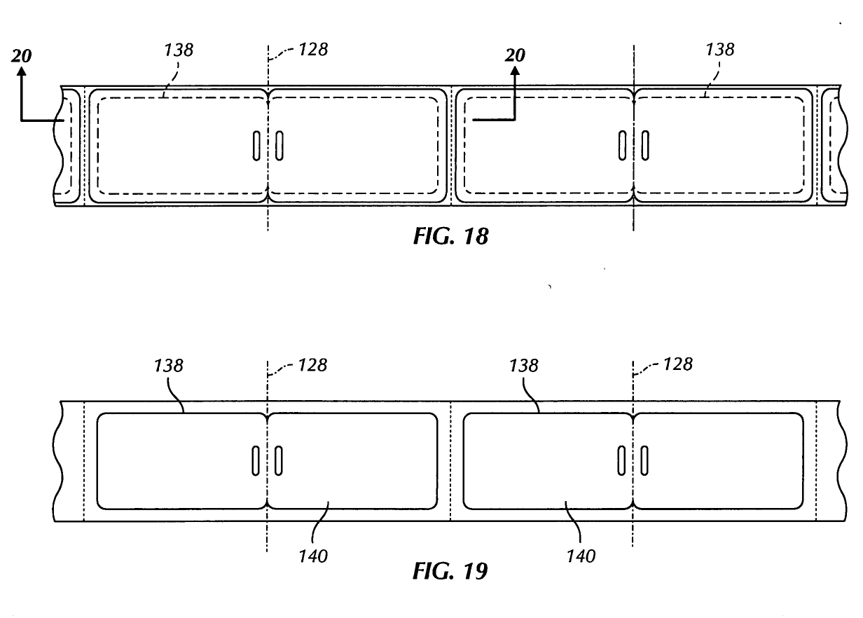

As shown in FIG. 12, the liner cuts 138 may be spatially located within one of the halves 124 or 126 (e.g., the verso half 124 as shown) such that the liner section 140 does not extend spatially across the fold line 128 as shown in FIG. 13. Alternatively, as shown in FIGS. 18, 19, and 20, each of the liner cuts 138 may be spatially located within the entire face stock 118 such that the liner section 140 extends spatially across the fold line 128. In these latter embodiments, the curl of the face stock 118 is mitigated equally on both halves 124 and 126.

With additional reference to FIG. 5, the label printer 104 may be in communication with a computer 144 that is configured to drive the printer 104. As shown in FIG. 21, the printer 104 may include a spool 146 on which the roll of badge stock 100 may be mounted, which in turn operably mounts the roll of badge stock 100 in the printer 104. One example of a roll-fed label printer is Personal Label Printer, Model No. 9100, which is a thermal label printer available from Avery Dennison Corporation, Office Products North America, Brea, Calif. 92821. Another example is disclosed in U.S. patent application Ser. No. 10/979,879 filed Nov. 1, 2003, and entitled “A Label Printer that Dispenses Labels in Non-Peel or Automatic Peel Modes,” the entire disclosure of which is incorporated herein by reference. The computer 144 and the printer 104 may operate according to a software application executed by the computer 144 or by the printer 104 itself. An example of the operation of the printer 104 and software application may be found in “Personal Label Printer: Quick Start Guide” which is available as Part No. 1271002800, available from Avery Dennison Corporation, Office Products North America, Brea, Calif. 92821.

To make identification badges 102, a user may provide a system for making badges including a roll of badge stock 100, the printer 104, the computer 144, and a plurality of straps 136 (see FIGS. 3 and 4). The straps 136 may be conventional straps with clips for attaching to clothing that are typically used for identification badges. The user may then cause the printer 104 to print on the face stock 118. Depending on the desired badge, the verso half 124 and the recto half 126 of the face stock 118 may be printed upon. After printing, the stock badge 112 may be removed from the release liner 110 as described above to expose the adhesive layer 120. The removed stock badge 112 may then be folded about the fold line 128 also as described above. A strap 136 may then be inserted through the through hole 134 to produce an identification badge 102 as shown in FIGS. 3 and 4. After printing, a badge unit 122 may be removed from the roll of badge stock 100 by tearing along a corresponding weakening line 114.

Those skilled in the art will understand that the preceding embodiments of the present invention provide the foundation for numerous alternatives and modifications thereto. These other modifications are also within the scope of the present invention. Accordingly, the present invention is not limited to that precisely as shown and described in the present invention.

1. A roll of badge stock for printing identification badges with a roll-fed label printer, the roll of badge stock comprising:
a printing stock assembly including:
a longitudinally elongated release liner having a plurality of transversely disposed weakening lines that are spaced apart longitudinally along the release liner; and
a plurality of stock badges each including a face stock and an adhesive layer releasably adhered to the release liner in single-file manner discretely between the weakening lines, respectively, such that the printing stock assembly includes a plurality of badge units each including one of the stock badges and a panel of the release liner defined between successive weakening lines;
the face stock of each of the stock badges being divided into a verso half and a recto half by a transverse fold line and including a pair of strap apertures disposed in a mirror image about the fold line so that each of the halves has a respective one of the strap apertures;
the verso half and the recto half of the face stock of each of the stock badges being printable upon by the label printer; and
each of the stock badges being foldable about the fold line when removed from the release liner with the adhesive layer of the verso half adhering to the adhesive layer of the recto half to form a two-sided identification badge such that:
the verso half of the face stock defining one side of the identification badge and the recto half defining the other side of the identification badge; and
the strap apertures substantially align with other to define a through hole through which a strap is receivable; and
a core about which the printing stock assembly is wound.

2. The roll of badge stock of claim 1 wherein the face stock of each of the stock badges has a longitudinal length and a transverse width that results in an identification badge having dimensions of about 3⅜ inches by about 2⅛ inches.

3. The roll of badge stock of claim 1 wherein each of the halves of the face stock of each of the stock badges has a longitudinal length and a transverse width, with the length being greater than the width.

4. The roll of badge stock of claim 3 wherein the strap apertures are transversely centered on the halves such that when one of the stock badges is folded about the fold line, the resulting identification badge has a portrait orientation.

5. The roll of badge stock of claim 3 wherein the strap apertures are longitudinally centered on the halves such that when one of the stock badges is folded about the fold line, the resulting identification badge has a landscape orientation.

6. The roll of badge stock of claim 1 wherein the weakening lines include perforations.

7. The roll of badge stock of claim 1 wherein the release liner includes a plurality of liner cuts defining a plurality of liner sections that are spatially located within the face stock of each of the stock badges such that when one of the face stocks is removed from the release liner, a corresponding one of the liner sections remains adhered to the removed one of the face stocks with a peripheral section of the adhesive layer of the removed one of the face stocks being exposed.

8. The roll of badge stock of claim 7 wherein each of the liner cuts is spatially located within one of the halves of the corresponding face stock such that the corresponding liner section does not extend spatially across the fold line.

9. The roll of badge stock of claim 7 wherein each of the liner cuts is spatially located within the corresponding face stock such that the corresponding liner section extends spatially across the fold line.

10. A printing stock assembly for printing identification badges with a roll-fed label printer, the printing stock assembly including:
a release liner having a plurality of spaced apart weakening lines; and
a plurality of stock badges each including a face stock and an adhesive layer;
the stock badges being releasably attached to the release liner in single-file manner between the weakening lines, respectively;
the face stock of each of the stock badges including a verso half and a recto half divided by a fold line;
the face stock of each of the stock badges also including a pair of strap apertures formed in the verso and recto halves in a mirror image about the fold line; and
when one of the stock badges is removed from the release liner, the adhesive layer is exposed and the face stock is foldable about the fold line such that the adhesive layer of the verso half is adherent to the adhesive layer of the recto half to form a two-sided identification badge with the strap apertures aligned with each other to receive a strap.

11. The printing stock assembly of claim 10 further comprising a plurality of badge units each including one of the stock badges and a panel of the release liner defined between successive weakening lines;
each of the badge units being removable from the printing stock assembly at the weakening lines.

12. The printing stock assembly of claim 10 wherein the face stock of each of the stock badges has a length of about 6¾ inches and a width of about 2⅛ inches.

13. The printing stock assembly of claim 10 wherein each of the halves of the face stock of each of the stock badges has a longitudinal length and a transverse width, with the length being greater than the width.

14. The printing stock assembly of claim 13 wherein the strap apertures are transversely centered on the halves such that when one of the stock badges is folded about the fold line, the resulting identification badge has a portrait orientation.

15. The printing stock assembly of claim 13 wherein the strap apertures are longitudinally centered on the halves such that when one of the stock badges is folded about the fold line, the resulting identification badge has a landscape orientation.

16. The printing stock assembly of claim 10 wherein the release liner includes a plurality of liner cuts defining a plurality of liner sections that are spatially located within the face stock of each of the stock badges such that when one of the face stocks is removed from the release liner, a corresponding one of the liner sections remains adhered to the removed one of the face stocks with a peripheral section of the adhesive layer of the removed one of the face stocks being exposed.

17. The printing stock assembly of claim 16 wherein each of the liner cuts is spatially located within one of the halves of the corresponding face stock such that the corresponding liner section does not extend spatially across the fold line.

18. The printing stock assembly of claim 16 wherein each of the liner cuts is spatially located within the corresponding face stock such that the corresponding liner section extends spatially across the fold line.

19. A method for making an identification badge, the method comprising:
providing a roll-fed label printer;
providing a roll of badge stock operatively loaded in the label printer, the roll of badge stock including:
a printing stock assembly including:
a release liner having a plurality of spaced apart weakening lines; and
a plurality of stock badges each including a face stock and an adhesive layer;
the stock badges being releasably attached to the release liner in single-file manner on the release liner between the weakening lines, respectively;
the face stock of each of the stock badges including a verso half and a recto half divided by a fold line; and
the face stock of each of the stock badges also including a pair of strap apertures formed in the verso and recto halves in a mirror image about the fold line;
a core about which the printing stock assembly is wound;
printing on the face stock of one of the stock badges;
removing the printed stock badge from the release liner such that the adhesive layer thereof is exposed; and
folding the removed stock badge about the fold line such that the exposed adhesive layer of the verso half is adherent to the adhesive layer of the recto half and the strap apertures are aligned with each other to form a through hole.

20. A method of claim 19 further comprising:
providing a strap; and
inserting the strap through the through hole.

21. A method of claim 19 wherein the printing step comprises:
printing on both the verso half and the recto half of the face stock.

22. A method of claim 19 wherein the printing stock assembly includes a plurality of badge units each including one of the stock badges and a panel of the release liner defined between successive weakening lines, the method further comprising:
detaching the badge unit with the printed stock badge from the printing stock assembly at the weakening lines thereof prior to removing the printed stock badge from the release liner.

23. A system for making identification badges, the system comprising:
a roll-fed label printer;
a computer in communication with and for controlling the label printer;
a roll of badge stock operatively loaded in the label printer, the roll of badge stock including:
a printing stock assembly including:
a release liner having a plurality of spaced apart weakening lines; and
a plurality of stock badges each including a face stock and an adhesive layer;
the stock badges being releasably attached to the release liner in single-file manner on the release liner between the weakening lines, respectively;
the face stock of each of the stock badges including a verso half and a recto half divided by a fold line; and
the face stock of each of the stock badges also including a pair of strap apertures formed in the verso and recto halves in a mirror image about the fold line;
when one of the stock badges is removed from the release liner, the adhesive layer is exposed and the face stock is foldable about the fold line such that the adhesive layer of the verso half is adherent to the adhesive layer of the recto half to form a two-sided identification badge with the strap apertures aligned with each other to form a through hole;
a core about which the printing stock assembly is wound and mounted to the label printer; and
a plurality of straps each configured to be receivable in the through hole of an identification badge formed by one of the stock badges.
